(19) United States
(12) Patent Application Publication
(10) Pub. No.: US 2022/0272989 A1
(43) Pub. Date: Sep. 1, 2022

(54) PLANT EXTRACT FOR CONTROLLING PARASITIC NEMATODES

(71) Applicant: UNIVERSITEIT GENT, Gent (BE)

(72) Inventors: Tina KYNDT, Gent (BE); Maaike PERNEEL, Mariakerke (BE); Jonas DE KESEL, Mariakerke (BE); Eva DEGROOTE, Gent (BE)

(21) Appl. No.: 17/627,918

(22) PCT Filed: Jul. 14, 2020
(86) PCT No.: PCT/EP2020/069866

§ 371 Date: Jan. 18, 2022

(30) Foreign Application Priority Data
Jul. 16, 2019 (EP) 19186438.8

(51) Int. Cl. A01N 65/08; A01N 25/02; A01N 25/30; A01P 5/00

(52) U.S. Cl. CPC A01N 65/08; A01N 25/02; A01N 25/30; A01P 5/00

(57) ABSTRACT

The present invention is in the field of agricultural pathogen control through induction of systemic plant defense. More specifically the invention relates to extracts of a plant belonging to the Cucurbitaceae and their use for protecting plants against plant pathogens, in particular parasitic nematodes The invention also provides compositions comprising the same, methods of making the same, and methods of controlling plant disease.

### FIELD OF THE INVENTION

The present invention is in the field of agricultural pathogen and pest control.

More specifically the invention relates to extracts of Cucurbitaceae plants or parts thereof, and their use for protecting plants against disease and pests, in particular parasitic nematodes. The invention also provides compositions comprising the same, methods of making the same, and methods of controlling plant disease.

### BACKGROUND OF THE INVENTION

Plants are subject to multiple potential disease-causing agents, including plant-pathogenic bacteria, fungi, oomycetes, mites, insects and plant-parasitic nematodes, which are responsible for significant economic losses in agriculture.

Bacteria are prokaryotic single-celled microorganisms, generally ranging from 1-2 μm in size that are present on all plant surfaces (epiphytes) and inside plants (endophytes) where they can behave as beneficial or pathogenic to the host. Plant pathogenic bacteria cause many serious diseases of plants throughout the world, and their symptoms range from spots, mosaic patterns or pustules on leaves and fruits, or smelly tuber rots, crown galls to plant death.

Fungi are eukaryotic heterotrophic micro-organisms, that can reproduce both sexually and asexually via the production of spores and other structures. Most phytopathogenic fungi belong to the Ascomycetes and the Basidiomycetes. Spores may be spread long distances by air or water, or they may be soil borne.

Oomycetes are fungus-like organisms. They include some of the most destructive plant pathogens including the genus Phytophthora, which includes the causal agents of potato late blight and sudden oak death. Particular species of oomycetes are responsible for root rot. Nematodes are active, flexible, elongate organisms that live on moist surfaces or in liquid environments, including films of water within soil and moist tissues within other organisms. There are numerous plant-parasitic nematode species, including various root knot nematodes (e.g. Meloidogyne sp.), lesion nematodes (e.g. Pratylenchus sp.), cyst nematodes (e.g. Heterodera sp.), dagger nematodes (e.g. Xiphinema sp.) and stem and bulb nematodes (e.g. Ditylenchus sp.), among others. Tylenchid nematodes (members of the order Tylenchida), including the families Heteroderidae, Meloidogynidae, and Pratylenchidae, are the largest and most economically important group of plant-parasitic nematodes. Nematode species grow through a series of lifecycle stages and molts. Typically, there are five stages and four molts: egg stage; J1 (i.e. first juvenile stage); M1 (i.e. first molt); J2 (second juvenile stage; sometimes hatch from egg); M2; J3; M3; J4; M4; A (adult). Juvenile (“J”) stages are also sometimes referred to as larval (“L”) stages. Nematode parasites of plants can inhabit all parts of plants, including roots, developing flower buds, leaves, seeds, and stems.

Compositions, methods and agents for controlling infestations by plant pests or pathogens have been provided in several forms. Biological and cultural control methods, including plant quarantines, have been attempted in numerous instances. In some crops, plant resistance genes have been identified that allow microbial resistance or tolerance. Chemical compositions such as nematicides have typically been applied to soil in which plant parasitic nematodes are present. However, there is an urgent need for safe and effective control measures. Factors relating to the disadvantages of current control strategies include heightened concern for the sustainability of agriculture, and new government regulations that may prevent or severely restrict the use of many available agricultural chemical antifungal, antibacterial and anthelminthic agents.

Chemical agents are often not selective, and exert their effects on non-target organisms, effectively disrupting populations of beneficial microorganisms, for a period of time following application of the agent. Chemical agents may persist in the environment and only be slowly metabolized. Nematicidal soil fumigants such as chloropicrin and methyl bromide and related compounds are highly toxic. These agents may also accumulate in the water table or the food chain, and in higher trophic level species. They may also act as mutagens and/or carcinogens to cause irreversible and deleterious genetic modifications.

The bionematicide market is dominated by microbials, accounting for more than 78.5% of the turnover (Markets and Markets 2017). Bacillus firmus and Paecilomyces lilacinus are the two most important microbials that are commercially used to control nematode infection. Furthermore, peel extracts of citrus fruits, pomegranate peel extracts and leaf extracts of certain plants have been demonstrated to have some direct nematicidal activity, for example by inhibiting egg hatching or killing the nematodes (Okeniyi, M. 0. et al, 2013; Regaieg H. et al, 2017; Saxena R. et al, 2004). Also in vitro and direct antimicrobial effect of pumpkin peel extract has been demonstrated (Badr et al., 2001; Malik et al, 2012). In vitro studies by Gryzbeck et al., 2016, showed some nematicidal potential of Cucurbita pepo seed extracts.

The present invention provides alternative agents and methods for plant pathogen control, in particular that work indirectly through the plant, i.e. via a mechanism of systemic plant defense activation. This phenomenon is sometimes also referred to as systemic acquired resistance or priming.

### SUMMARY OF THE INVENTION

It is an objective of the present invention to provide a natural agent that can induce systemic defense in plants against biotic stress. Said agent can be used to combat plant pathogens and/or pests, in particular nematodes, bacteria, viruses, phytopathogenic fungi, oomycetes, mites, Thrips and insects e.g. aphids, more in particular nematodes.

In one embodiment, the agent is a plant extract or composition comprising it. The plant extract is derived from a plant of the family of Cucurbitaceae, and more specific the genera Cucurbita or Cucumis. Any plant part can be used, but is particularly effective when extracted from a (fresh) fruit or vegetable of a plant of the family of Cucurbitaceae, even more particular of the peel of said fruit or vegetable.

The extract can be used as an agricultural plant-protecting agent and has a plant disease-preventing or-limiting effect, a plant health-promoting effect, a plant immunity-activating effect, or the combined effect.

The invention further provides in one embodiment a method of inducing systemic resistance to biotic stress in a plant and in a further embodiment a method of treating, inhibiting or reducing infection with a plant pathogen. These methods comprise applying a plant extract as provided herein and/or composition comprising it to the plant or parts thereof, e.g. its leaves or its seeds. Hence, by stimulating the immune system of the plant the health of the plant is improved as compared to non-treated and infected plants. Remarkably and as shown in the examples, said effect is obtained without any direct (physical) contact of the agent with the pathogenic organism. For example, it was demonstrated in the present invention that application of the extract to the leaves of a plant induced defense in the plant against pathogens residing in the roots.

In another aspect the invention relates to a method of manufacturing the plant extract as described herein using any extraction method known in the art, in particular water extraction, such as e.g. cold or hot water extraction or extraction at room temperature. Said method comprises mixing a buffer with a solid fraction of plants, or parts thereof, of the family of Cucurbitaceae, in particular from the genus Cucurbita or Cucumis. The mixture is sieved or allowed to settle to form a supernatant and precipitated solids. The supernatant is separated from the precipitate and used as the plant extract.

In a particular embodiment, the extract is a water extract from the peels of a fruit of a plant of the family of Cucurbitaceae, in particular from the genus Cucurbita or Cucumis. The processed fruit product of the embodiments can be any processed product or byproduct obtained from the fruit during food or other production.

In another embodiment, the invention provides a plant seed coated with an extract, wherein the extract is from a plant or part thereof belonging to the genus Cucurbita or Cucumis. In a further embodiment, the invention encompasses a foliar spray comprising an extract of a plant, or part thereof, belonging to the genus Cucurbita or Cucumis.

The present embodiments provide a plant extract that is capable of inducing and/or increasing the natural defense of a plant against infections of a pathogen in a systemic way. The plant extract is able to achieve this protecting effect in the whole plant even when applied only on a part of the plant, or when applied at relatively low concentrations. Of particular advantage is that the present plant extract can be used pre-emptively (e.g. to seedlings or non-infected plants) as well as curative and require only a simple formulation. The use as a priming agent will delay, or even prevent the damage to the plant when infected.

The invention further discloses the use of the plant extract described herein for preventing or suppressing plant disease, in particular for increasing the resistance of a plant against a pathogen. In one embodiment, the pathogen is a parasitic nematode such as e.g. a root-knot nematode, a root-lesion nematode or/and a cyst nematode, even more in particular a nematode belonging to the genus selected from the group consisting of Meloidogyne, Heterodera, Globodera, Pratylenchus, Aphelenchoides, Xiphinema, Radopholus, Bursaphelenchus, Rotylenchulus, Nacobbus, Longidorus, Ditylenchus and Trichodorus. In one embodiment, the invention provides the use of the plant extract described herein for preventing or suppressing plant disease, in particular for increasing the resistance of a plant against root-rot nematodes.

In a further embodiment, the present invention discloses a composition or formulation comprising the extract as described herein and a diluent, an additive, a plant (micro) nutrient, an emulsion stabilizer, a surfactant, a buffer, a crop oil, a drift inhibitor and/or an (inert) substratum. In particular, the composition is a foliar spray or a seed coating. Furthermore, the extract or composition can further comprise or be used in combination with one or more biostimulants, fertilizers, herbicides, fungicides, bactericides, acaricides, nematicides and/or insecticides. In particular the composition is an agrochemical composition comprising a plant extract as provided herein and at least one excipient.

In another embodiment, the extract or composition is applied to a plant or (specific) part thereof. In the alternative, the extract can be applied to the soil or substrate surrounding the plant thereby specifically targeting the roots of the plant. Preferred application methods are foliar treatment (e.g. by spraying) or seed treatment (e.g. by seed coating), in particular foliar treatment. A further application is soil treatment (e.g. by drip irrigation). Plant parts to be treated can be a seed, fruit, fruit body, leaf, stem, shoot, stalk, flower, root, tuber or rhizome. The invention further relates to the use of the plant extract or composition provided herein in agriculture applications.

### BRIEF DESCRIPTION OF THE FIGURES

FIG. 1. Systemic defense activation effect in rice versus root-knot nematodes after foliar treatment with cold extracts from different plant parts of Cucurbita moschata ‘Muscat’ (pumpkin, 15 g dry weight source material/100 ml buffer, 15%). Inoculation with 250 second stage juveniles of root-knot nematode Meloidogyne graminicola on the root system was done at 24 h after foliar spraying of these extracts. Data was taken 2 weeks later. Extracts from peelings (Cucurbitaceae Peeling Extracts: COPE) show highest efficacy in terms of reduction of number of galls as well as nematode development inside the root tissue. (a) Number of galls per rice plant, (b) Shoot and root length, and (c) number of egg-laying females (as measurement of nematode development). Bars show the average ±SE of 8 plants per treatment. *: statistically different from control plants (P<0.05).

FIG. 2. Systemic defense activation effect in rice versus root-knot nematodes after foliar treatment with COPE of different Cucurbitaceae fruits: cucumber (Cucumis sativus; 5%), zucchini (Cucurbita pepo; 6%), pumpkin ‘muscat’ (15%). Inoculation with 250 second stage juveniles of root-knot nematode Meloidogyne graminicola on the root system was done at 24h after foliar spraying of the extracts. Data was taken 2 weeks later. (a) Shoot height and root length (b) Number of galls per rice plant. (c) nematode development inside the rice roots. Zucchini and pumpkin COPE lead to strongly hampered nematode development. Bars show the average ±SE of 8 plants per treatment. *: statistically different from control plants (Ctrl).

FIG. 3. Systemic defense activation effect in rice versus root-knot nematodes after irrigation with COPE from zucchini (6%) or pumpkin ‘muscat’ (15%). Inoculation with 250 second stage juveniles of root-knot nematode Meloidogyne graminicola on the root system was done at 24h after spraying of the extracts. Data was taken 2 weeks later. (a) Shoot height (SH) and root length (RL). (b) Number of galls per rice plant. Bars show the average ±SE of 8 plants per treatment. *: statistically different from control plants (Ctrl).

FIG. 4. Systemic defense activation effect in tomato versus root-knot nematodes after foliar treatment with COPE from zucchini (6%) or pumpkin ‘muscat’ (15%). Inoculation with 250 second stage juveniles of root-knot nematode Meloidogyne incognita on the root system was done at 24 h after spraying of the extracts. Data was taken 31 days later. (a) Shoot height and root length. (b) Number of galls per rice plant. Bars show the average ±SE of 8 plants per treatment. *: statistically different from control plants (Ctrl).

FIG. 5. Systemic defense activation effect in rice versus root-knot nematodes after foliar treatment with COPE from pumpkin ‘buttternut’ (15%). Inoculation with 250 second stage juveniles of root-knot nematode Meloidogyne graminicola on the root system was done at 24h after spraying of the extracts. Data was taken 2 weeks later. Bars show the average ±SE of 8 plants per treatment. (a) Shoot height and root length. (b) Number of galls per rice plant. *: statistically different from control plants.

FIG. 6. Systemic defense activation effect in rice versus migratory nematodes after foliar treatment with COPE from pumpkin ‘muscat’ or zucchini at two different concentrations.

Inoculation with 250 second stage juveniles of migratory nematode Pratylenchus zeae was done at 24 h after extract spraying. (a) root length, (b) shoot length, (c) number of nematodes inside the plant roots, (d) nematode reproduction factor (final population/initial population) (e) number of nematodes in 20 ml of substrate around the plants. (a-d) Bars show the average ±SE of 8 plants per treatment. (e) Bars show the average ±SE of 3 random substrate samples of 20 mL*: statistically different from control plants.

FIG. 7. Systemic defense activation effect in rice versus migratory nematodes after foliar treatment with COPE from pumpkin ‘muscat’ extracted at different temperatures. Cold: extracted at 4° C. Room Temperature (RT): extracted at room temperature (22° C.) and stored at room temperature for one day before application. 40: extracted at 40° C. Hot: extracted at 100° C. for 10 minutes, and cooled down for 1 hour. Inoculation with 300 migratory nematodes Pratylenchus zeae was done at 24 h after extract spraying. The experiment was evaluated at 25 days after nematode inoculation. Bars show the average ±SE of the number of nematodes counted in 8 plants per treatment. *: statistically different from control plants.

FIG. 8. Systemic defense activation in rice versus migratory nematodes after foliar treatment with extracts prepared from Cucurbitaceae peelings, seedlings or seeds, in comparison with systemic defense activator COS-OGA (Fytosol®, fytofend, Singh et al., 2019). Inoculation with 300 migratory nematodes Pratylenchus zeae was done at 24 h after extract spraying. The experiment was evaluated at 25 days after nematode inoculation and the number of nematodes per plant was counted. Control (water treatment). Bars show the average ±SE of 8 plants per treatment. Different letters indicate statistically significant differences.

FIG. 9. Scheme for examining systemic gene expression by RNA-sequencing on treated plants.

### DESCRIPTION OF THE INVENTION

As used herein, the singular forms “a”, “an”, and “the” include both singular and plural referents unless the context clearly dictates otherwise. The terms “comprising”, “comprises” and “comprised of” as used herein are synonymous with “including”, “includes” or “containing”, “contains”, and are inclusive or open-ended and do not exclude additional, non-recited members, elements or method steps. The term “about” as used herein when referring to a measurable value such as a parameter, an amount, a temporal duration, and the like, is meant to encompass variations of +/−20% or less, preferably +1-10% or less, more preferably +/−5% or less, of and from the specified value, insofar such variations are appropriate to perform in the disclosed invention. It is to be understood that the value to which the modifier “about” refers is itself also specifically, and preferably, disclosed. Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any >3, >4, >5, >6 or >7 etc. of said members, and up to all said members. All references, and teachings specifically referred to, cited in the present specification are hereby incorporated by reference in their entirety. Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. Reference throughout this specification to “one embodiment” or “an embodiment” means that a particular feature, structure or characteristic described in connection with the embodiment is included in at least one embodiment of the present invention.

The present invention relates to methods and compositions which can be used to stimulate plant defense and/or immune responses against plant pathogens and pests, e.g. nematodes, bacteria, viruses, fungi, oomycetes, mites, thryps and insects. In particular, the invention provides a method for controlling plant pathogens, in particular nematodes, said method comprising applying on or to said plant an extract of a plant or of a part of a plant belonging to the family Cucurbitaceae, more specific of the genera Cucumis and Cucurbita.

By indirectly acting via the plant, these extracts have a minimal impact on beneficial soil organisms, thereby making them more suitable crop protection agents. In addition, it was demonstrated that these extracts have no negative effect on plant growth and more specific on for example root and shoot development (e.g. length, number and/or height). Hence, the plant extract of the invention can be used to improve tolerance to pathogens, in particular nematodes. The present invention demonstrates that the extract inhibits the attraction, invasion, migration, establishment of feeding sites, feeding proliferation and/or maturation of plant parasitic nematodes, and/or reduce the number of egg-laying females on the plant, and/or reduce lesion sites by migratory nematodes or number of feeding sites such as e.g. the production of galls or syncytia by sedentary nematodes.

The present invention generally relates to a plant extract that can be used as biological control agent for systemic defense activation against biotic stresses, such as various plant pathogens. The plant extract can be used to stimulate the defenses of a plant by inducing its resistance to such biotic stresses in a systemic way also referred to as “priming” and as demonstrated in the present examples. Systemic effects are defined as those effects occurring in the whole body of the plant, not only in one specific treated part. The plant extract can also be used to prevent or treat, or at least inhibit or alleviate, plant diseases. As used herein, priming is an intrinsic part of induced resistance, i.e. the plant takes defensive measures against the potential attacker while also preparing its defensive system for a faster and/or stronger reaction in the future. Priming stimuli trigger direct changes in the plant that are crucial for the enhanced defensive behavior. In contrast to the expression of directly induced defenses, however, no or only minimal fitness costs in terms of growth and seed or fruit production are associated with defense priming. Thus, the memory of the stimuli, low fitness costs, a more robust defense, and better performance in the presence of the challenge are relevant checkpoints to experimentally ascertain the presence of defense priming. Hence the current invention encompasses the use a the plant extract described herein as a priming agent.

The plant extract is able to perform this beneficial effect without showing strong toxicity to the plant and the plant pathogen at the working concentrations that are used to treat the plant, e.g. in the case of nematodes below the concentration of about 15-20%. Thus, the plant extract when applied to the plant will reduce infection by the plant pathogen by inducing and promoting the natural defense mechanisms of the plant against pathogens, in particular systemically, as demonstrated herein.

The plant extract of the present invention is an extract obtained from the plant of the family Cucurbitaceae, in particular from a part of the plant, such as e.g. leaves, stems, roots, flowers, fruits or seeds of said plant, or a combination thereof, more in particular from the peel (also referred to as “shell”) of said fruit. In one embodiment, the plant or part thereof is fresh, i.e. not dried before extraction. The Cucurbitaceae, also called cucurbits and the gourd family, are a plant family consisting of about 965 species in around 95 genera, the most important of which are (and which are part of the invention):
Cucurbita-e.g. Cucurbita argyrosperma, Cucurbita cordata, Cucurbita digitata (fingerleaf gourd), Cucurbita ecuadorensis, Cucurbita ficifolia (figleaf gourd or chilacayote), Cucurbita foetidissima (stinking gourd or buffalo gourd); Cucurbita lundelliana, Cucurbita maxima (winter squash or pumpkin), Cucurbita argyrosperma subsp. argyrosperma, syn. Cucurbita mixta (pipian or cushaw pumpkin); Cucurbita moschata (cultivars called squash or pumpkin, including butternut squash and Dickinson pumpkin); Cucurbita okeechobeensis, Cucurbita palmata, Cucurbita pedatifolia, Cucurbita pepo (cultivars including acorn squash, field pumpkin, yellow summer squash and zucchini), Cucurbita radicans (calabacilla or coyote gourd);
Lagenaria-e.g. Lagenaria abyssinica; Lagenaria breviflora; Lagenaria guineensis; Lagenaria rufa; Lagenaria siceraria (bottle gourd, calabash); Lagenaria sphaerica;
Citrullus-e.g. Citrullus lanatus (watermelon); Citrullus colocynthis (bitter apple), Citrullus ecirrhosus, Citrullus rehmii;
Cucumis-the cucumbers; Cucumis melo (melon), Cucumis subg. Cucumis, Cucuminis subg. Humifructus-subgenera Cucumis sativus;
Luffa—the common name is also luffa-e.g. L. acutangula; L. aegyptiaca; L. astorii; L. echinata; L. graveolens; L. operculata; L. quinquefida; L. saccata; L. sepium is now a synonym of Luffa operculata.

In a particular embodiment the plant extract is derived from the fruit of a plant of the genus Cucurbita or Cucumis, in particular from a pumpkin, squash, zucchini, melon, gourd, or cucumber, more in particular from a pumpkin, melon, zucchini or cucumber.

More specific, the plant extract is obtained from the peel of the fruit of the herein identified plants. Plant extraction is a process that aims to extract certain components present in plants. It is a solid/liquid separation operation wherein the plant or a part(s) thereof is placed in contact with a fluid or a gas (water vapour or supercritical fluids), referred to as the solvent or buffer. The plant components of interest are then solubilised and contained within the solvent. The solution thus obtained is the “plant extract”. Subsequently, the obtained extract or pulp can be sieved (e.g. with mesh size ranging from 50 μm, 100 μm, 200 μm, 300 μm, 400 μm or 500 μm to 1 mm, 1.5 mm or 2 mm; in particular between 500 μm and 1.5 mm) and optionally a further excipient or diluent can be added. After extraction, the solvent can optionally be eliminated to isolate the obtained plant extract and possibly to obtain a dry extract (e.g. freeze-drying). In particular the extract is a crude extract.

The plant extract can be obtained from the leaves, stem, roots, seedlings, peels, seeds, fruit flesh or whole fruits/vegetables as raw material and/or from a processed fruit/vegetable product. Such a processed fruit product is a processed form of a peel, such as a byproduct or waste product, typically obtained during production or processing from the original fruits or vegetables.

A typical production process for a (fresh) peel extract involves washing the fruits if deemed necessary, and peeling them, manually or mechanically. These peels are then collected and blended, mixed or grinded resulting in a pulp. In one embodiment, blending or mixing is preferably allowed to continue for at least 1 or 2 minutes, in particular between 2 and 10 minutes.

The solvent used in the method of producing the plant extract is preferably selected from a group consisting of ethanol, methanol, hexane, water or any suitable buffer such as e.g. a water-based buffer having a pH range between 5 and 8 (e.g. Na phosphate buffer, K phosphate buffer, Tris buffer, phosphate buffered saline, or a borate buffered saline), including combinations thereof. In a particular embodiment, the solvent is water.

Different types of extraction methods are possible. In one embodiment, at least the extraction step (mixing and optionally sieving) is done under “cold” conditions or in a cold room, i.e. in a temperature about and between 1° C. to 15° C., more specific between 1° C. and 10° C., even more specific between 2° C. and 8° C. This is also referred to as a cold extract. Optionally, said extract is stored in a cold room (less than about 10° C. and up to −20° C.) up till application to the plant. In another embodiment, extraction is done at room temperature, i.e. a temperature about and between 16° C. and 30° C., in particular about 20 to 22° C. In another embodiment, extraction is done at about 40° C. i.e. temperature between 45° C. and 35° C., more specifically between 38° C. and 42° C.

In another embodiment, the plants or part thereof, such as e.g. peelings of the fruits/vegetables, are added to or dissolved in the buffer, after which this solution is boiled or heated to a temperature of about 95° to 150° C., for at least 2 minutes e.g. such as between and about 2-15 minutes, in particular between 5-10 minutes or about 10 minutes. After that, these parts are mixed or grinded resulting in a pulp which may be subsequently sieved. This is also referred to as a hot extract. Said extract can then be stored at room temperature up till application to the plant.

In one embodiment, the obtained extract is diluted, such as e.g. by adding the same solvent that was used during the extraction step, i.e. mixed with water or another solvent to form the plant extract. Hence, the plant extract is a liquid extract or a liquid formulation. In a further embodiment, the obtained extract is concentrated, for instance by evaporation of a portion of the solvent, to form the plant extract.

In a particular embodiment the obtained extract is filtered or sieved once or multiple times, such as twice, to remove any suspended or larger particles. The filtered supernatant could then be used as plant extract. In an optional step the filtered supernatant is centrifuged to form a pellet of suspended particles that were not removed during the filtering step(s). The supernatant is separated from this pellet and used as plant extract in liquid form. Optional dilution or concentration can be done as mentioned herein.

As such, the invention provides a process for the preparation of a composition comprising a plant extract, said process comprising at least the following steps:

(a) providing fresh plants or plants parts, in particular peelings from the fruits, of a plant of the family Cucurbitaceae, in particular of the genus Cucurbita or Cucumis;

(b) blending or mixing the material provided under (a), optionally in the presence of a buffering agent, in particular water or Na—P;

(c) sieving the blend or mixture; and

(d) optionally adding a surfactant or other excipient defined herein.

In one embodiment, at least steps (b) and (c) are performed at a temperature about and between 1° C. and 40° C.

In another embodiment, the invention provides a process for the preparation of a composition comprising a plant extract, said process comprising at least the following steps:

(a) providing fresh plants or parts thereof, in particular peelings from the fruits, of a plant of the family Cucurbitaceae, in particular of the genus Cucurbita or Cucumis;

(b) boiling said plants or parts in water or a water-based buffer (in particular Na-phosphate) for minimum 2 minutes and up till 10 to 15 minutes, at about 95° C. to 150° C.;

(c) blending or mixing the boiled plants or parts in the buffer;

(c) sieving the blend or mixture; and

(d) optionally adding a surfactant or other excipient defined herein.

In a specific embodiment, the methods provided herein process peels from a pumpkin, squash, zucchini, melon, gourd, or cucumber, more in particular from a pumpkin, melon, zucchini or cucumber.

The plant extract of the embodiments can be used, optionally in diluted or concentrated form, directly in the various methods to be further disclosed herein. Alternatively, the plant extract is used to form a composition as provided herein.

In one aspect the plant extract or the composition is used in a method of inducing systemic resistance to a biotic stress in a plant. The method comprises applying the plant extract and/or composition of the invention to the plant, after which systemic plant immunity will be activated. The applying step could be performed according to various embodiments. For instance, the plant extract or composition could be sprayed on a plant to be treated, watered on a plant, added to the substrate, such as soil, peat, compost, vermiculite, perlite, sand or clay, in which a plant is growing, etc. In a specific embodiment, the plant extract is sprayed on a plant, in particular on the leaves of a plant.

Another aspect of the embodiments relates to a method of treating or preventing, or at least inhibiting or alleviating, pathogen or pest damage in a plant. The method comprises applying the plant extract and/or composition to the plant. The applying step can be performed as discussed above, such as by spraying or watering.

The invention provides methods, plant extracts and compositions for controlling plant pathogens or pests. Plant pathogens/pests refer to organisms that cause infectious diseases in plants and include bacteria, viruses, fungi, thryps, oomycetes, mites, insects and nematodes. In a particular embodiment, the plant pathogens are parasitic nematodes. The term “controlling plant parasitic nematodes” refers to reducing the overall negative effect of plant parasitic nematodes on plants such that the plants experience a decreased amount of negative effects by said nematodes as compared to plants not treated with the extract. For example, typical root symptoms indicating nematode attack are root knots or galls, root lesions, excessive root branching, injured root tips and stunted root systems. Symptoms on the above-ground plant parts indicating root infection are a slow decline of the entire plant, wilting even with ample soil moisture, foliage yellowing and fewer and smaller leaves. These are, in fact, the symptoms that would appear in plants deprived of a properly functioning root system. Bulb and stem nematodes produce stem swellings and shortened internodes. Bud and leaf nematodes distort and kill bud and leaf tissue. In some cases, yield loss may take place with no visible symptoms. The overall negative effect by plant parasitic nematodes may be reduced, such as by reducing the overall number or density of plant parasitic nematodes (i.e., decrease in nematode population) on the plant or in the soil or by reducing the severity or extent of negative effects of the plant parasitic nematodes (i.e., nematode population remains unchanged but exhibit fewer detrimental effects such as e.g. cyst or gall formation, number of lesions, growth reduction, yield losses, etc.).

As used herein, the term “nematode” refers to multicellular animals in the phylum Nematoda. “Plant parasitic nematode” refers to nematode parasites of plants which can be found in/on plant roots, seeds, flowers, leaves, stems, or the soil in which the plant is growing. Plant parasitic nematodes feed on all parts of the plant, including roots, stems, leaves, flowers and seeds. Plant parasites are classified on the basis of their feeding habits into the broad categories migratory ectoparasites, migratory endoparasites, and sedentary endoparasites. Sedentary endoparasites, which include the root knot nematodes (Meloidogyne spp.) and cyst nematodes (Globodera and Heterodera) induce feeding sites (“giant cells” in the case of root knot nematodes and “syncytia” for cyst nematodes) and establish long-term infections within roots. “Cyst nematodes” (genera Heterodera and Globodera) and “root-knot nematodes” (genus Meloidogyne), in particular, cause significant economic loss in plants, especially crop plants. Examples of cyst nematodes include, H. schachtii (sugar beet cyst nematode), H. avenae (cereal cyst nematodes), H. glycines (soybean cyst nematode), H. sacchari (sugarcane cyst nematode), H. carotae (carrot cyst nematode), G. pallida (white potato cyst nematode) and G. rostochiensis (yellow potato cyst nematode). Root-knot nematodes include, for example, M. graminicola, M. javanica, M. incognita, M. arenaria, M. chitwoodi, M. artiellia, M. fallax, M. hapla, M. microtyla, M. partityla, M. panyuensis, M. naasi, M. exigua, M. enterolobii and M. paranaensis. These pathogens establish “feeding sites” in the plant, by causing the morphological transformation of plant cells into giant cells or syncytia, which block the flow of nutrients and photosynthesis products. Hence, nematode “infection” refers to invasion of and feeding upon the tissues of the host plant. Other nematodes that cause significant damage include the “root-lesion” nematodes such as Pratylenchus, particularly P. penetrans, which infects maize, rice and vegetables, P. brachyurus which infects pineapple, P. zeae, which infects cereals, sugarcane and coffee, P. coffeae, which infects coffee and banana, and P. thornei, which infects wheat.

In one aspect, “plant parasitic nematodes” include microorganisms from the genera Meloidogyne, Heterodera, Globodera, Pratylenchus, Aphelenchoides, Xiphinema, Radopholus, Bursaphelenchus, Rotylenchulus, Nacobbus, Longidorus, Ditylenchus en Trichodorus, and in particular from the genera Meloidogyne, Heterodera and Pratylenchus. In particular, the nematode species is selected from the group consisting of: Heterodera glycines, Heterodera schachtii, Globodera rostochiensis, Meloidogyne incognita, Meloidogyne graminicola, Globodera pallida, Heterodera avenae, Heterodera sacchari, Heterodera zeae, Heterodera carotae, Pratylenchus penetrans, Pratylenchus coffeae, Pratylenchus neglectus, Pratylenchus zeae, Pratylenchus loosi, Meloidogyne javanica, Meloidogyne arenaria, Meloidogyne hapla, Meloidogyne fallax, Meloidogyne chitwoodi. Meloidogyne exigua, Aphelenchoides besseyi, Aphelenchoides fragariae, Xiphinema index, Radopholus similis, Bursaphelenchus xylophilus, Rotylenchulus reniformis, Nacobbus abberans, Longidorus elongatus, Ditylenchus destructor, Ditylenchus dipsaci, Ditylenchus angustus and Tricochodorus minor. In a particular embodiment, the nematodes are members of the order Tylenchida.

Examples of phytopathogenic bacteria include the genera Pseudomonas, Ralstonia, Rhizobium, Agrobacterium, Xanthomonas, Erwinia, Xyllela, Dickeya, Pectobacterium, Streptomyces, Clavibacter, Candidatus Liberibacter, Bacillus, Corynebacterium and Burkholderia. Examples of phytopathogenic viruses include Potato Virus X, Potato Virus Y, Tobacco Mosaic Virus, Cucumber Mosaic Virus, Tomato Yellow Leaf Curl Virus, Tomato Spotted Wilt Virus and Citrus Tristeza Virus. Fungal plant pathogen species are primarily in the phyla Ascomycota and Basidiomycota. Among ascomycetes, plant pathogens are in various classes such as the Dothideomycetes (e.g., Cladosporium spp.), Sordariomycetes (e.g., Magnaporthe spp.), or the Leotiomycetes (e.g., Botrytis spp.). Basidiomycetes are represented by the two largest plant pathogen groups: the rusts (Pucciniomycetes) and the smuts (spread among the subphylum of Ustilaginomycotina). Examples of phytopathogenic fungi (including biotrophic, hemi-biotrophic, necrotrophic fungi) include the genera Magnaporthe, Botrytis, Puccinia, Fusarium, Blumeria, Mycosphaerella, Colletotrichum, Ustilago, Phakopsora, Alternaria, Sclerotinia, Cladosporium and Rhizoctonia.Examples of phytopathogenic oomycetes (formerly classified as fungi) are species of the genera Pythium and Phytophtora. Pythium-induced root rot is a common crop disease.

Furthermore, also plaques of thrips and the like can be controlled by the methods and extracts of the present invention. Thrips belong to the Order Thysanoptera including Thrips, Franklienella and Scirtothrips.Examples of highly destructive mites include, but are not limited to, the two-spotted spider mite (Tetranychus urticae), the tomato russet mite (Aculops lycopersici), the European red mite (Panonychus ulmi), the citrus red mite (Panonychus citri), flat mites such as Breyipalpus sp and tarsonemid mites such as the rice panicle mite (Steneotarsonemus spinki).

Herbivory is a form of consumption in which a heterotrophic organism consumes plants. Herbivorous insects and/or mites are arthropods that feed on plant tissues. They injure a plant by for example feeding on cell contents, chewing, sucking phloem sap or acting as vectors for viral plant diseases. Examples of insect pests that can have a destructive impact on crops and that can be controlled by the present methods include, but are not limited to, the cotton bollworm (Helicoyerpo amigara), the tobacco whitefly (Bemisia tabaci), the diamondback moth (Plutella xylostella), the red flour beetle (Tribolium castaneum), the green peach aphid (Myzus persicae), the armyworm (Spodoptera spp.), the western flower thrips (Frankliniella occidentalis) and the brown planthopper (Nilaparyato lugens). In one embodiment, the insects pests are sucking or stinging insects.

In a particular embodiment, the control of plant pathogens is realized by an improved resistance to detrimental effects of pathogens and parasites, and results in an enhancement in the overall health of the subject plants, such as a greater production of some desirable parameter, such as for example the amount of harvested crop produced.

The term “improved resistance to disease,” or “defense activation” as used herein, refers to an increase of plant defense in a healthy plant or a decrease in disease severity of a plant or a population of plants, or in the number of diseased plants in a plant population. The term “systemic” refers to the fact that not only the locally treated plant part (e.g. the leaves) has enhanced resistance to a certain disease, but also non-treated plant tissues (e.g. the roots) are protected from the disease.

A particular advantage is that the plant extract of the invention exhibits no (significant) toxicity and hence has no harmful effects on the treated plant and on non-target organisms at a working concentration adapted to be applied to a plant.

The present invention also encompasses (the use of) a composition or formulation comprising the plant extract of the invention. An “agrochemical composition” as used herein means a composition for agrochemical use, such as use in the agrochemical industry, including agriculture, horticulture, floriculture and home and garden uses for protecting plants or parts of plants, crops, bulbs, tubers, fruits (e.g. from harmful organisms, diseases or pests) as herein defined, comprising at least the extract as defined herein, optionally with one or more additives favoring optimal dispersion, atomization, deposition, leaf wetting, distribution, retention and/or uptake of the active compound(s). Typically such composition or formulation further comprises at least one additional component or excipient such as a surfactant, a (solid or liquid) diluent and/or an emulsion stabilizer, which serves as a carrier. The (agrochemical) formulation generally comprises between 1 and 99,9%, between 5 and 99%, between 10 and 99%, or between 20 and 90% by weight of the plant extract. The concentration of the excipient in the agrochemical formulation generally ranges from 1 to 50% by weight. With “surfactant” is meant herein a compound that lowers the surface tension of a liquid, allowing easier spreading. The surfactant can be a detergent, an emulsifier (including alkyl polyglucosides glycerol ester or polyoxyethylene (20) sorbitan monolaurate), a dispersing agent (including sodium chloride, potassium chloride, potassium nitrate, calcium chloride or starch of corn), a foaming agent (including derivates of tartric acid, malic acid or alcohols), a penetration enhancer, a humectant (including ammonium sulfate, glycerin or urea) or a wetting agent of ionic or non-ionic type or a mixture of such surfactants. In particular, the surfactants used in the composition as defined herein are penetration enhancers, dispersing agents or emulsifiers. The term “penetration enhancer” is understood herein as a compound that accelerates the uptake of active ingredient through the cuticle of a plant into the plant, i.e. the rate of uptake, and/or increases the amount of active ingredient absorbed into the plant. Classes of substances known as penetration enhancers, include alkyl phosphates, such as tributyl phosphate and tripropyl phosphate, and naphthalene sulphonic acid salts. With “dispersing agent” is meant a substance added to a suspension, usually a colloid, to improve the separation of particles and to prevent settling or clumping. The term “emulsifier” as used herein refers to a substance that stabilizes an emulsion, i.e. a mixture of two or more liquids. Mention can be made of the emulsifiers sold under the trade names Tween® 20, which essentially comprises polyoxyethylene (20) sorbitan monolaurate (polysorbate 20), and Radia®, which essentially comprises alkyl polyglycosides. In one embodiment, the invention provides a composition comprising an extract of the peel of the fruit of a plant of the genus Cucurbita or Cucumis and an agriculturally and/or horticulturally acceptable carrier. Optionally said composition further comprises a surfactant. In one embodiment, the peels are from a pumpkin, squash, zucchini, melon, gourd, or cucumber, more in particular from a pumpkin, melon, zucchini or cucumber.

As an example, a surfactant comprises one or more of the following components: castor oil ethoxylate, rapeseed methyl ester, alkyl phosphates, tributyl phosphate, tripropyl phosphate, naphthalene sulphonic acid salts, organic sulfonate/2-methylpentane-2,4-diol, alkylpolyglucoside, siloxanes derivates, alkylsulfonates, polycarboxylates, lignosulfonates, alkoxylated triglycerides, fatty amines polymers, dioctylsulfosuccinates or polyoxyethylene (20) sorbitan monolaurate (polysorbate 20).

An additive, a plant (micro) nutrient, a buffer, a crop oil, a drift inhibitor and/or an (inert) substratum can also be part of the composition. Typically the extract of the invention may be administered to a plant in a suitable agriculturally acceptable formulation, including but not limited to, a growing medium such as soil or hydroponic liquid medium, dusts, granules, solution concentrates, emulsifiable concentrates and wettable powders. The term “agriculturally/horticulturally acceptable” indicates that the formulation is non-toxic and otherwise acceptable for application to a plant, whether applied indoors (e.g. in a contained environment) or outdoors (e.g. in a non-contained environment that is exposed to other plant, animal and human life). The formulation may include additives such as solvents, for example ketones, alcohols, aliphatic ethers, fillers and carriers, for example clay and minerals. The general types of solid compositions are dusts, powders, granules, pellets, prills, pastilles, tablets, filled films (including seed coatings) and the like, which can be water dispersible (“wettable”) or water soluble. Films and coatings formed from film forming solutions or flowable suspensions are particularly useful for seed treatment. Sprayable formulations are typically extended in a suitable medium before spraying. Such liquid and solid formulations are formulated to be readily diluted in the spray medium, usually water, but occasionally another suitable medium like an aromatic or paraffinic hydrocarbon or vegetable oil. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting.

Liquid diluents include, for example, water, NN-dimethylalkanamides (e.g., NN dimethylformamide), limonene, dimethyl sulfoxide, N-alkylpyrrolidones (e.g., N methylpyrrolidinone), alkyl phosphates (e.g., triethyl phosphate), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters, alkyl and aryl benzoates and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol, cresol and benzyl alcohol. Liquid diluents also include glycerol esters of saturated and unsaturated fatty acids (typically C6-C22), such as plant seed and fruit oils (e.g., oils of olive, castor, linseed, sesame, corn (maize), peanut, sunflower, grapeseed, safflower, cottonseed, soybean, rapeseed, coconut and palm kernel), animal sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

In a particular embodiment, the invention provides a fibrous composition comprising a non-woven fiber and an effective amount of the plant extract as provided herein, covalently attached or stably adsorbed to the fiber.

The composition or formulation will typically contain effective amounts of the plant extract as described herein. An “effective amount” means that they are used in a quantity which allows to obtain the desired effect but which does not give rise to any significant phytotoxic symptom on the treated plant. In one embodiment the concentration of the extract administered on or to the plant ranges from 1 to 90% (90 g dry weight raw or source material/100 ml buffer), in particular up to 50%, 40%, 30%, 20% or 15% (15 g dry weight raw or source material/100 ml buffer); or in further dilutions ranging from about 1% to about 15%. In one embodiment, the extract is administered in a concentration ranging from about 2% to about 20%, more in particular at a concentration of 2% to 15%.

The extract of the invention can be used individually (derived from one genus or species of Cucurbitaceae, in particular of the genus Cucurbita or Cucumis, plant or fruit) or mixed with another extract (of another genus or species of Cucurbitaceae, in particular of the genus Cucurbita or Cucumis, plant or fruit) to prepare the composition according to the invention, optionally in combination with an excipient. Combinations with other extracts, e.g. from other plant families are also possible. It is also possible for it to be packaged and used further as combination composition such as a kit of parts.

According to the method of the present invention, the extract or composition according to the invention can be applied once to a plant (part)/crop, or it can be applied two or more times after each other with an interval between every two applications as can be determined by the person skilled in the art.

Any plant/crop can be treated. The term “plant (or plants)” is a synonym of the term “crop” which is to be understood as a plant of economic importance and/or a men-grown plant. The methods, extracts and compositions of the present invention may be applied to any monocot or dicot plant or a tree, depending on the pathogen (e.g. nematode) control desired. Exemplary plants protected by the present invention with plant-parasitic nematodes species include, but are not limited to, alfalfa: Meloidogyne hapla, Meloidogyne incognita, Meloidogyne javanica, Ditylenchus dipsaci, Pratylenchus spp., Paratylenchus spp., Xiphinema spp.; banana: M. incognita, M. arenaria, M. javanica, Radopholus similis, Helicotylenchus multicinctus, Pratylenchus coffeae, Rotylenchulus reniformis; beans and peas: Meloidogyne spp., Heterodera spp., Belonolaimus spp., Helicotylenchus spp., Rotylenchulus reniformis, Paratrichodorus anemones, Trichodorus spp.; cassava: Meloidogyne spp., Rotylenchulus reniformis; cereals: Meloidogyne naasi (barley, wheat, rye), Heterodera avenae; chickpea: Meloidogyne spp., Heterodera cajani, Rotylenchulus reniformis, Hoplolaimus seinhorsti, Pratylenchus spp.; citrus: Meloidogyne spp., Tylenchulus semipenetrans, Radopholus similis, Radopholus citrophilus, Hemicycliophora arenaria, Pratylenchus spp., Bolonolaimus longicaudatus, Trichodorus spp., Paratrichodorus spp., Xiphinema spp.; clover: Meloidogyne spp., Heterodera trifolii; corn: Meloidogyne incognita, Pratylenchus spp., Paratrichodorus minor, Longidorus spp., Hoplolaimus columbus; cotton: Meloidogyne incognita, Belonolaimus longicaudatus, Rotylenchulus reniformis, Hoplolaimus galeatus, Pratylenchus spp., Tylenchorhynchus spp., Paratrichodorus minor; grapes: Meloidogyne spp., Xiphinema spp., Pratylenchus vulnus, Tylenchulus semipenetrans, Rotylenchulus reniformis; grasses: Pratylenchus spp., Longidorus spp., Paratrichodorus christiei, Xiphinema spp., Ditylenchus spp.; peanut: Meloidogyne hapla, Meloidogyne arenaria, Ditylenchus spp., Pratylenchus spp., Criconemella spp., Belonolaimus longicaudatus; pigeon pea: Meloidogyne spp., Heterodera cajani, Rotylenchulus reniformis, Hoplolaimus seinhorsti, Pratylenchus spp.; potato: Meloidogyne spp., Globodera rostochiensis, Globodera pallida, Pratylenchus spp., Trichodorus primitives, Ditylenchus spp., Paratrichodorus spp., Nacobbus aberrans; rice: Meloidogyne spp., Aphelenchiodes besseyi, Ditylenchus angustus, Hirchmanniella spp., Heterodera spp.; small fruits: Meloidogyne spp.; Pratylenchus spp., Xiphinema spp., Longidorus spp., Paratrichodorus christiei, Aphelenchoides spp.; soybean: Meloidogyne incognita, Meloidogyne javanica, Heterodera glycines, Belonolaimus spp., Hoplolaimus columbus; sugar beet: Meloidogyne spp., Heterodera schachtii, Ditylenchus dipsaci, Nacobbus aberrans, Trichodorus spp., Longidorus spp., Paratrichodorus spp.; sugar cane: Meloidogyne spp., Pratylenchus spp., Radopholus spp., Heterodera spp., Hoplolaimus spp., Helicotylenchus spp., Scutellonema spp., Belonolaimus spp., Tylenchorhynchus spp., Xiphinema spp., Longidorus spp., Paratrichodorus spp.; tobacco: Meloidogyne spp., Pratylenchus spp., Tylenchorhynchus claytoni, Globodera tabacum, Trichodorus spp., Xiphinema americanum, Ditylenchus dipsaci, Paratrichodorus spp.; and tomato: Meloidogyne spp., Pratylenchus spp.

In a specific embodiment, the plants to be treated are these crops with the greatest estimated losses due to phytopathogens i.e. corn, cotton, cucurbits, leguminous vegetables, peanut, solanaceous vegetables (e.g. tomato), lettuce, strawberry, potato, onion, wheat, rice, banana, tree fruits (e.g. apple, citrus), coffee, soybean, sugarcane, sugar beet and tobacco, more in particular solanaceous vegetables (e.g. tomato, potato, eggplant, capsicum and chillies) and wheat. In one embodiment, the plant to be treated belongs to the genus Oryza (e.g. rice) or to the genus Solanum (e.g. tomato).

In a further embodiment of the present invention, the extract or a composition comprising the extract is applied to a plant, directly or indirectly. Any appropriate plant part can be treated or used including plant organs (e.g., leaves, stems, roots, etc.), seeds, and plant cells and progeny of the same. In the alternative, the extract or composition can be applied to the soil surrounding the plant, however with direct contact with the roots. The applying of the extract is prior to planting, at planting, or after planting. In one embodiment, contacting includes direct application to a plant. All or part of a plant including, without limitation, leaves, stems, roots, propagules (e.g., cuttings), fruit, etc., may be contacted with the extract described herein. Contacting may also be carried out indirectly, via application, e.g., to soil or other plant substrates but making uptake by the plant possible.

Suitable application methods include high or low-pressure spraying, immersion, atomizing, foaming, fogging, coating, and encrusting. Other suitable application procedures can be envisioned by those skilled in the art. In a particular embodiment, the extract of the invention is applied to the parts of the plant above ground or to the foliage of the plant by spraying e.g. by the use of mechanical sprayers. Sprayers convert a formulation of the invention which is mixed with a liquid carrier, such as water or fertilizer, into droplets. The droplets can be any size. Boom sprayers and air blast sprayers can also be used to apply formulations of the invention to pre-emergent or post-emergent crops. Air blast sprayers inject formulations of the invention mixed with a liquid carrier into a fast-moving air stream. Boom sprayers, aerial sprayers, ultra-low volume sprayers, drip irrigation, sprinkler irrigation, and foggers can also be used to apply formulations of the invention. Where the formulations of the invention are in a solid, powder or granule form, they can be applied with granule or dust application equipment. Formulations of the invention can also be applied as a fumigant to soil, plant media, plants, or plant tissues.

In another embodiment, seeds of a plant are coated with the extract of the invention (“coated seeds”). Any appropriate seed coating method known the skilled person can be used. E.g. seeds can be treated with the extract of the invention in multiple ways including, without limitation, via spraying or dripping, drenching, or pellet application. Spray and drip treatment can be conducted, for example, by formulating an effective amount of the extract in an agronomical acceptable carrier, typically aqueous in nature, and spraying or dripping the composition onto seed via a continuous treating system (which is calibrated to apply treatment at a predefined rate in proportion to the continuous flow of seed), such as a drum-type of treater. Such methods include those that can advantageously employ relatively small volumes of carrier so as to allow for relatively fast drying of the treated seed. Large volumes of seeds can be efficiently treated. Batch systems, in which a predetermined batch size of seed and signal molecule compositions are delivered into a mixer, can also be employed. Systems and apparatuses for performing these processes are commercially available from numerous suppliers. The present invention also provides a seed coated with the extract/composition of the present invention, in particular a seed coated with an extract, wherein the extract is from a plant or part thereof belonging to the genus Cucurbita or Cucumis. In one embodiment the extract for coating is from a peel from the fruit of a plant of the the genus Cucurbita or Cucumis.

In another aspect, the extract or composition can be applied to the soil directly, e.g. by drip irrigation or drench application (soil drench). A soil drench applies the extract, optionally mixed with water, to the soil around the base of a plant so that its roots can absorb the extract.

In a specific embodiment, the extract of the present invention can be applied to a plant as provided herein alone, in combination or in a mixture with other compounds. Suitable other compounds include effective amounts of other agricultural or horticultural biologicals and/or chemicals, such as herbicides, insecticides, nematicides, molluscicides, bactericides, acaricides, fungicides, and/or plant growth regulators or fertilizers.

In yet another embodiment the invention provides a method for the manufacture (′or the production of which is equivalent wording) an (agrochemical) composition according to the invention, comprising formulating the extract of the invention together with at least one customary agrochemical auxiliary agent. Suitable manufacturing methods are known in the art and include, but are not limited to, high or low shear mixing, wet or dry milling, drip-casting, encapsulating, emulsifying, coating, encrusting, pilling, extrusion granulation, fluid bed granulation, co-extrusion, spray drying, spray chilling, atomization, addition or condensation polymerization, interfacial polymerization, in situ polymerization, coacervation, spray encapsulation, cooling melted dispersions, solvent evaporation, phase separation, solvent extraction, sol-gel polymerization, fluid bed coating, pan coating, melting, passive or active absorption or adsorption. Customary agrochemical auxiliary agents are well-known in the art and include, but are not limited to aqueous or organic solvents, buffering agents, acidifiers, surfactants, wetting agents, spreading agents, tackifiers, stickers, carriers, fillers, thickeners, emulsifiers, dispersants, sequestering agents, anti-settling agents, coalescing agents, rheology modifiers, defoaming agents, photo-protectors, anti-freeze agents, biocides, penetrants, mineral or vegetable oils, pigments and drift control agents or any suitable combination thereof.

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

### Examples

Material and Methods

Plant Material

Rice (Oryza sativa)

All experiments were performed in the japonica cultivars Nipponbare or Kitaake. Seeds were germinated on wet tissue paper at 30° C. in the dark for three days, followed by transfer to individual PVC tubes (for nematode infection) containing SAP (Reversat et al., 1999). SAP (sand-absorbent polymer) is a mixture of fine silica sand and ultra-absorbent acrylic copolymer (AquaPerla, DCM, Grobbendonk, Belgium) in a ratio of 1 kg sand to 1.5 g of dry copolymer. Before use, each tube was washed in soapy water and dried in an oven at 70° C. for two days. The tubes were placed inside plastic boxes in a completely randomized manner to minimize environmentally induced bias and transferred to a growth chamber at 28° C. with 16 hours of light. The first two days after transfer, the tubes were covered with a polyethylene film (Saran Film, Dow Chemicals, Midland, USA) to prevent excessive evaporation. Seedlings were watered three times per week with 8 ml of Hoagland solution (Hoagland, 1938).

Tomato (Solanum lycopersicum)

Tomato seeds, cv. Moneymaker (Vreeken's Zaden, Dordrecht, the Netherlands) were sown on autoclaved potting soil, covered with polyethylene film, and placed at 24° C. for eight days. Seedlings were then transferred to individual SAP-filled pots and placed in a growth chamber at 24° C. Plants were watered three times per week with 25 ml of quarter-strength Hoagland solution for the first two weeks and half-strength thereafter.

Preparation of Extracts and Application

Different types of extracts were prepared as follows.

Cold extracts were prepared in a cold room (4° C.) from fruits/vegetables (from organic agriculture) or from different plant tissues including fruit flesh, fruit peeling, leaves, stems roots, or seedlings of plants. The fresh material was blended for 2 minutes in 200 mL 0.1M Na-phosphate buffer. Then the extract was sieved (mesh: 1 mm) and 0.2% Tween20 was added as surfactans. The concentration of the extract was expressed in % as follows: gram of dry weight of source material/100 mL of extraction buffer. Cucurbitaceae peeling extracts are referred to herein as COPE.

In addition, the same extraction was also done at higher temperatures, such as room temperature (20-22° C.) or at about 40° C.

Seed extracts were prepared by following exactly the same procedure, except for the use of fresh seeds as source material.

Hot extraction was performed by boiling peelings from fruits/vegetables (from organic agriculture) for 10 min, after which they were blended for 2 minutes in 0.1M Na-phosphate buffer. Extracts were cooled down for 1 hour until room temperature. Then the extract was sieved (mesh: 1 mm) and 0.2% Tween20 was added as surfactans.

Fourteen-day old plants were treated with fresh extract (7 ml/plant) and 24h later inoculation was done. Control plants (Ctrl) were mock-treated with Na-phosphate buffer+0.2% Tween20.

Nematode Cultures

Meloidogyne graminicola culture

M. graminicola was extracted from infected Echinocloa crus-galli roots grown in potting soil at 25° C. Roots were washed until most soil was removed, after which they were cut into short fragments (with special care taken to cut open any visible galls). The cut material was put in 200 μm pore diameter sieves which were put into a tap water bath at room temperature for three days. The water was then poured over a 20 μm mesh sieve to collect the nematodes. The sieve surface was washed with approximately 50 ml of non-demineralized water, which was collected into a beaker before it could seep through the sieve.

The number of nematodes in five 100 μl samples taken from the nematode suspension was counted under a stereo microscope and averaged to determine inoculum concentration.

Meloidogyne incognita Culture

M. incognita was extracted from infected tomato plants (cv. Moneymaker) roots grown in potting soil at 24° C. Nematodes were collected, counted and inoculated using the same procedure as described for M. graminicola above.

Pratylenchus zeae Culture

A pure culture of P. zeae grown on carrot disks was kindly provided by Giuseppi Lucarelli (Horto Service, Noicattaro, Italy). The nematodes were multiplied by inoculating approximately 100 nematodes on an ethanol-sterilized carrot disk, placing this disk in a sealed petri dish and incubating the dish at 24° C. for six weeks in the dark.

Nematode Infection Experiments

Infection experiments with M. graminicola were performed by inoculating rice plants 14 days after transfer to SAP by introducing the desired amount of J2 juveniles next to the root system using a micro pipette. Plants were harvested 14 days after inoculation. At this point, the plants were phenotyped by measuring the shoot and root length with a ruler. Root systems were then stained in acid fuchsine as described in (Byrd et al., 1983) and left to destain in glycerol containing 1 ml/I fuming HCl added for approximately ten days. The number of galls and nematodes was then counted using a binocular microscope.

Infection experiments with M. incognita were performed in the same manner as those with M. graminicola, except that tomato plants were used as a host. Plants were harvested at 31 days after inoculation instead of 14 days. At this point, the plants were phenotyped by measuring the length with a ruler. Galls were stained and counted as described above.

Infection experiments with P. zeae were performed by inoculating rice plants 14 days after transfer to SAP by introducing 250-300 nematodes next to their root system using a micro pipette. Plants were analyzed 25 days after inoculation. At this point, the plants were phenotyped by measuring the shoot and root length with a ruler. The nematodes inside the root systems were stained using acid fuchsine and counted as described above. Nematodes in the substrate around the plants were also counted by the decantation-sieving method. 3 random samples of 500 μl each were counted under a binocular microscope.

For each experiment, 8 individual plants were used per treatment. For each parameter, the average and standard error of these 8 plants is shown in all bar graphs. Data was statistically analysed using a Student's T-test (α=0.05).

In one example, a well-known mixture COS-OGA (Fytosol®, Fytofend) was used as reference treatment, at the recommended dose of 0.5% foliar spray. According to a recent publication (Singh et al., 2019), this product provides systemic defense activity against root-knot nematodes in rice.

Gene Expression Profiling by RNA-Sequencing on Systemic Tissue in Tomato

Fourteen-day old tomato plants were treated with fresh cold peeling extract of zucchini (6%) as described above. Root material from 3 biological replicates of control plants and 3 biological replicates of treated plants were sampled at 4 days after treatment. Each biological replicate consisted of at least 4 individual plants that were pooled to minimize inherent biological variability. RNA was extracted using the RNeasy Mini Kit by Qiagen. Quality and concentration of the samples was assessed using NanoDrop 2000. Approximately one microgram of total RNA was used for 3′ mRNA-Seq library construction using the QuantSeq 3′ mRNA-Seq Library Prep Kit FWD for Illumina (Lexogen). To minimize lane effects the samples were multiplexed, using the multiplexing sequencing adapters provided in the Multiplexing Sample Preparation Oligo Kit (Illumina). Size selection of the library was performed on a 2% agarose gel (Low Range Ultra Agarose, Biorad 161-3107). The denatured library was diluted to a final concentration of 6 pM and loaded on a flow cell (Illumina). After cluster generation, the multiplexed library was sequenced on an Illumina NextSeq500 (75 cycles, single end, high output). Data-analysis was performed using Microsoft Open R (version 3.5.2). The raw data underwent a quality control via the fastqc function. Following the quality control, samples were trimmed (using Trimmomatic (Trimmomatic Manual: V0.32) and again their quality was checked. Trimmed data was mapped onto the annotated genome by making use of the STAR-mapper function (Dobin, 2019). After another quality control check, the files were merged per sample, in this way rendering 12 samples; 3 samples per treatment. Via BiocManager, the following packages were installed and used during further analysis of the data: GenomicRanges, Rsamtools, rtracklayer, GenomicAlignments, foreign, Matrix, stats and GenomicFeatures. The counttable of the data was generated using the summarize Overlaps function in R. Differentially expressed genes were detected using the DESEQ2 function to analyse the countable and applying a false discovery rate of 0.01 (adjusted p-values <0.01). The gene lists were analysed using Kegg (Kyoto Encyclopedia of Genes and Genomes-Release 91.0, Jul. 1, 2019) to identify significantly induced pathways.

### RESULTS

Example 1: Systemic Defense Activation Experiment with Cold Extracts Prepared from Fresh Material of Different Parts of the Cucurbita moschata ‘Muscat’ Plant: Shoot Application on Rice ↔Root-Knot Nematode Meloidogyne Graminicola

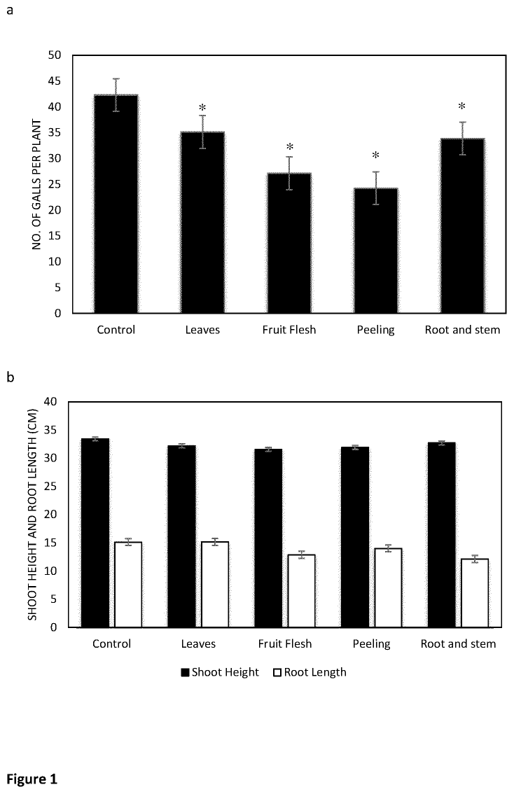

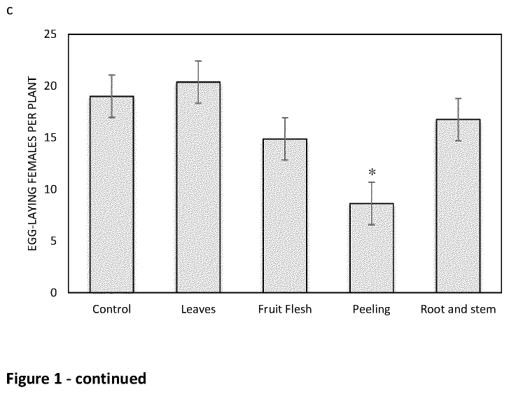

In this experiment, 5 cold plant extracts from different fresh plant parts of Cucurbita moschata ‘Muscat’ were investigated for systemic defense-inducing effect against root-knot nematode Melodoigyne graminicola in rice by spraying cold extracts on rice shoots 24h before nematode inoculation on the roots. Root galls were counted 14 days later and the plant length was measured. The number of egg-laying females in the infected root systems was evaluated as a measure for nematode development. The results show that cold extracts from fresh material of the different plant parts of Cucurbita moschata ‘Muscat’, all have systemic defense-inducing activity against root-knot nematodes, with a significant reduction in number of galls per plant (FIG. 1a). These extracts are well-tolerated by the plants, as there are no negative effects on root length and shoot height (FIG. 1b). Also, negative effects on nematode development were seen, mainly with peeling extracts (FIG. 1c).

Example 2: Systemic Defense Activation Experiment on Rice ↔Root-Knot Nematode Meloidogyne Graminicola

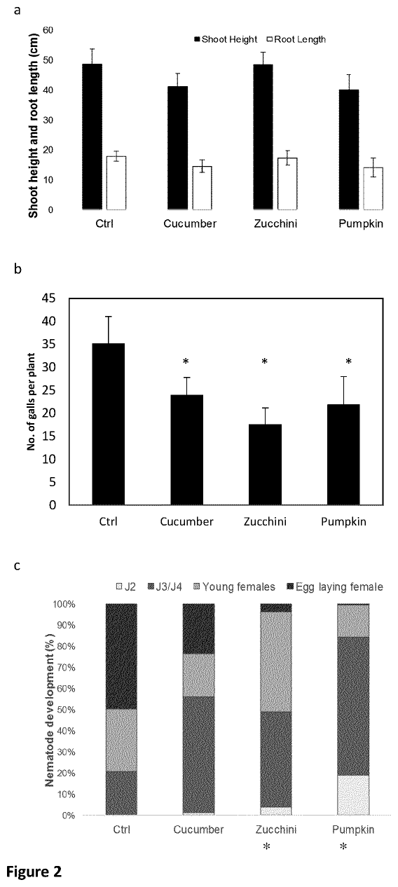

In this experiment, peelings from different Cucurbitaceae plants (Cucurbitaceae peeling extracts: COPE), including cucumber, pumpkin ‘Muscat’ and zucchini, were sprayed on the shoots 24h before inoculation with Meloidogyne graminicola on the roots. Nematode development was evaluated by categorizing the nematodes inside the root tissue in four classes: second stage juveniles (J2), developed juveniles (J3/J4), young females and egg-laying females. No significant effects on shoot or root growth were observed (FIG. 2a). The number of galls was reduced by ca. 50% for all extracts (FIG. 2b). Strong negative effects on nematode development in the rice roots were observed, mainly for the zucchini and pumpkin ‘Muscat’ extract, where almost no egg-laying females were found in the rice roots (FIG. 2c).

Example 3: Soil Application on Rice ↔Root-Knot Nematode Meloidogyne Graminicola

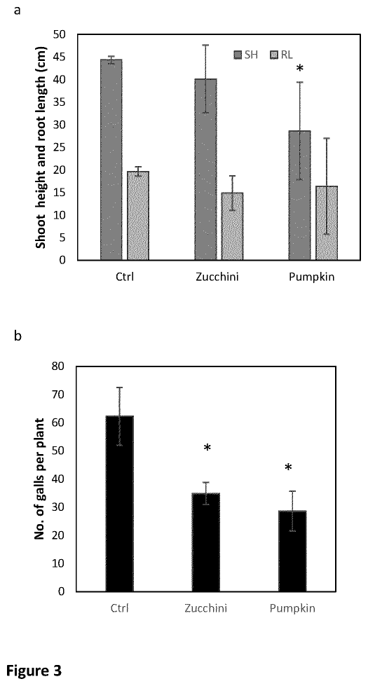

In this experiment, COPE was applied by drip irrigation on the substrate, 24h before inoculation. Similar reduction in gall formation (FIG. 3b) was seen as with leaf spraying (example 2).

Example 4: Systemic Defense Activation Experiment on Tomato ↔Root-Knot Nematode Meloidogyne incognita

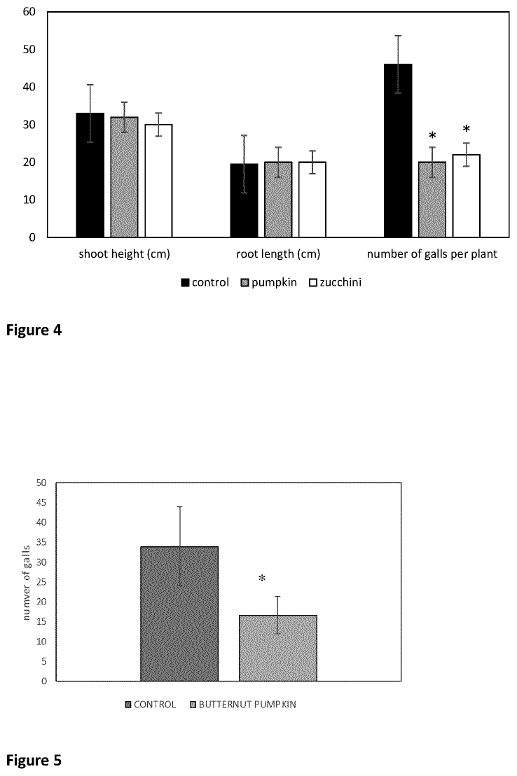

In this experiment, COPE was applied on two-week old tomato plants, 24h before inoculation with root-knot nematode Meloidogyne incognita. Two weeks later, no significant effects on shoot or root growth were observed (FIG. 4). The number of galls on the tomato roots is reduced by 50-60% for all COPE extracts (FIG. 4).

Example 5: Systemic Defense Activation Experiment with Extract from Pumpkin ‘Butternut Squash’ on Rice ↔Root-Knot Nematode Meloidogyne graminicola

In this experiment, COPE from another pumpkin variety, namely ‘butternut’ (squash), was applied on two-week old rice plants, 24h before inoculation with root-knot nematode M. graminicola. A similar effect, with about 50% reduction in number of galls (FIG. 5) was seen as with the ‘muscat’ variety (see examples 1 and 2).

Example 6: Systemic Defense Activation Experiment on Rice ↔Migratory Nematode Pratylenchus zeae and Investigation of Dose-Dependent Effects

In this experiment, COPE from pumpkin (‘muscat’) or zucchini was sprayed on two-week old rice plants, 24h before inoculation with migratory nematode Pratylenchus zeae.

The dose-dependency of the extracts was evaluated by working with 2 COPE concentrations, namely the same concentration as used in all previous examples (15% for pumpkin and 6% for zucchini) as well as a 2x diluted extract (7.5% for pumpkin and 3% for zucchini).

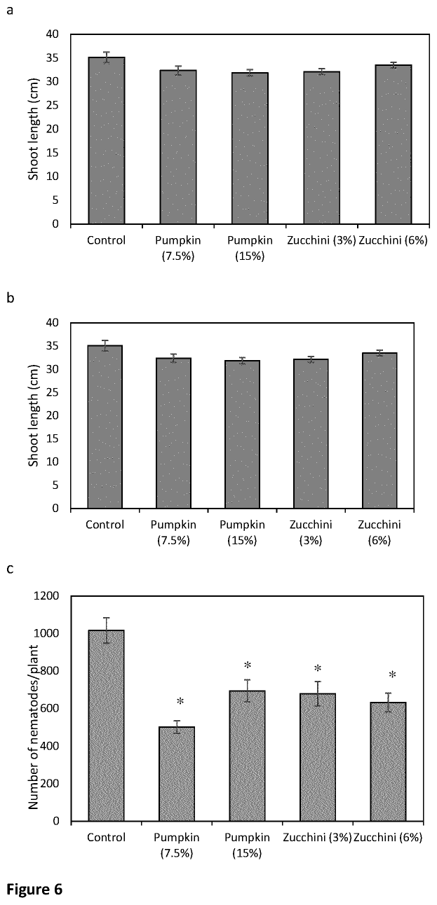

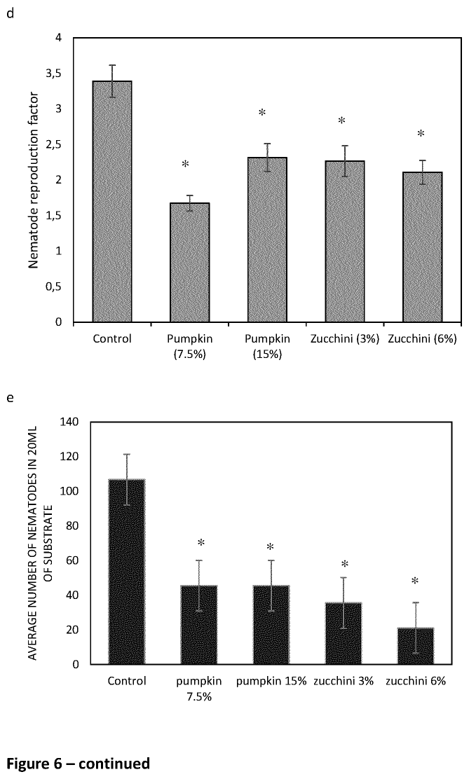

Twenty five days later, no significant effects on shoot or root growth were observed (FIGS. 6a and 6b). Remarkably, the number of nematodes inside the rice roots was reduced by 50-60% for all COPE treatments (FIG. 6c), and we observed a significant negative impact on the nematode reproduction factor (FIG. 6d). Noteworthy, no dose-effect was observed. Also, when analyzing the substrate in which the plants were grown, as a measure of nematode reproduction in the plant roots, a significant reduction in number of nematodes in the substrate around the plant roots was observed for all COPE treatments (FIG. 6e), demonstrating that the activated systemic defense prevents reproduction of the nematodes inside the plant roots.

Example 7: Comparing Different Extraction Methods

In this experiment, different extraction methods were evaluated, starting from pumpkin (‘muscat’) peelings: Cold extraction (as in the previous examples), extraction at room temperature (22° C.), extraction at 40° C. and hot extraction (boiling for 10 min). The extracts were applied on two-week old rice plants, 24h before inoculation with migratory nematode Pratylenchus zeae.

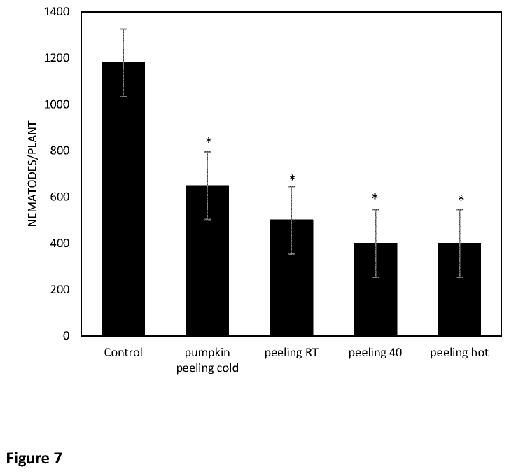

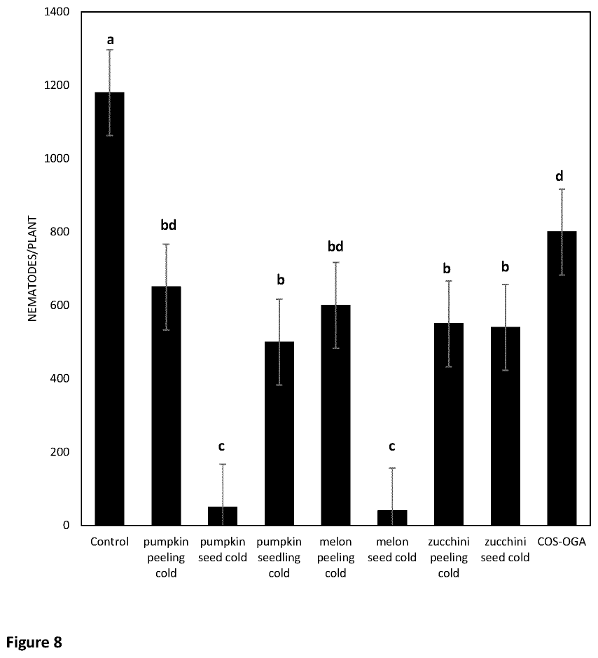

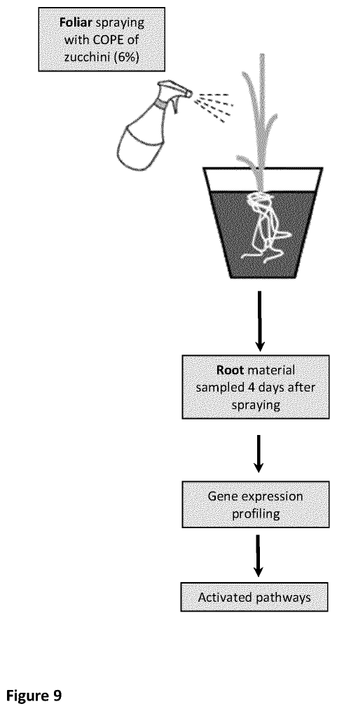

As shown in FIG. 7, the number of nematodes inside the rice roots was reduced by 50-70% for all treatments.

Example 8: Systemic Defense Activation Experiment of Seed Versus Peeling Extracts on Rice ↔Migratory Nematode Pratylenchus zeae

In this experiment, seeds, seedlings or peelings of different Cucurbitaceae were extracted at 4° C. (cold): melon (12%), pumpkin (15%), zucchini (6%). COS-OGA was used as a reference product with described systemic defense-induction capacity (Singh et al., 2019). The extracts were sprayed on two-week old rice plants, 24h before inoculation with migratory nematode Pratylenchus zeae. Significant reduction in number of nematodes was seen for all treatments. In addition, nematode reduction by use of the extracts was higher than with the commercial reference product.

Example 9: Systemic Induction of Plant Defense Pathways in Roots of Tomato after Foliar COPE Application

To confirm systemic defense induction by the plant extract of the invention, gene expression analysis (‘transcriptome analysis’) was done on roots of tomato plants 4 days after foliar spraying with COPE of zucchini (6%). Five pathways were found to be significantly (corrected p-value <0.01) activated in systemic tissue (Table 1). Thiamine biosynthesis is important for plant tolerance to biotic and abiotic stress. Zeatin biosynthesis is involved in cell cycle activation. Importantly, steroid biosynthesis, alpha-linolenic acid metabolism and secondary metabolites are all known to be involved in plant defense. Alpha-linolenic acid is the precursor of jasmonate. Two genes encoding allene-oxide synthase (AOS2 and AOS3), responsible for the first step in jasmonate biosynthesis, were strongly activated in the roots of the treated tomato plants, confirming the systemic effects of the treatments on plant defense.

TABLE 1
Systemic gene expression profiling by RNA-sequencing on roots of treated plants
reveals induction of plant defense, tolerance and growth related processes. The
significantly induced pathways and FDR-corrected p-values are shown in the table.
Also, known functions assigned to these pathways are given.

| Significantly activated | | |
|---|---|---|
| pathways | P-value | Function |
| Steroid biosynthesis | 7.619457e−05 | Sterols: structural components of cell |
| | | membranes; precursors of alkaloids (eg. α- |
| | | tomatine) and brassinosteroids; role in plant |
| | | defense |
| Alpha-Linolenic acid | 4.052710e−03 | Jasmonate biosynthesis; role in plant defense |
| metabolism | | |
| Thiamine metabolism | 1.011608e−02 | Vitamin B1 biosynthesis; role in plant tolerance |
| | | to abiotic and biotic stress |
| Zeatin biosynthesis | 6.301257e−03 | Cytokinin biosynthesis; role in cell division |
| Biosynthesis of secondary | 4.041069e−03 | Production of plant defense metabolites |
| metabolites | | |

### REFERENCES

Badr S E, Shaaban M, Elkholy Y M, Helal M H, Hamza A S, Masoud M S, El Safty M M. Nat Prod Res. 2011 September;25(16):1524-39.

Byrd, D. W., Kirkpatrick, T., Barker, K. R., et al., 1983. An improved technique for clearing and staining plant tissues for detection of nematodes. Journal of nematology, 15(1), pp. 142-3.

Faske, T. R. & Hurd, K., 2015. Sensitivity of Meloidogyne incognita and Rotylenchulus reniformis to Fluopyram. Journal of nematology, 47(4), pp. 316-21.

Grzybek M, Kukula-Koch W, Strachecka A, Jaworska A, Phiri A M, Paleolog J, Tomczuk K. Int J Mol Sci. 2016 Sep 1;17(91).

Mallik et al. International Journal of Pharmaceutical & Biological Archives 2012; 3(3): 555-560.

Hoagland and Arnon (1938). The water-culture method for growing plants without soil (Circular (California Agricultural Experiment Station), 347. ed.). Berkeley, Calif. : University of California, College of Agriculture, Agricultural Experiment Station.

Okeniyi, M. 0. et al., Academia Journal of Biotechnology 1(6): 081-086, August 2013.

Reversat, G. et al., 1999. Use of a mixture of sand and water-absorbent synthetic polymer as substrate for the xenic culturing of plant-parasitic nematodes in the laboratory. Nematology, 1(2), pp. 209-212.

Regaieg H. et al., Archives of Phytopathology and Plant Protection Volume 50, Issue 17-18, 8 Nov. 2017, Pages 839-849.

Saxena R. et al. Current Nematology 15(1,2): 39-45, 2004.

Singh et al., Plant Physiology and Biochemistry-Volume 142, September 2019, Pages 202-210.

1-15. (canceled)

16. A method for priming a plant against parasitic nematodes, the method comprising applying on or to a plant an extract of a plant, or a part thereof, belonging to the genus Cucurbita or the genus Cucumis.

17. The method according to claim 16, wherein the extract is from a plant selected from the group consisting of pumpkin, squash, zucchini, melon, gourd, and cucumber.

18. The method according to claim 16, wherein the plant part is selected from the leaves, stem, roots, seedlings, peels, seeds, fruit flesh, or whole fruits/vegetables of a plant of the genus Cucurbita or the genus Cucumis.

19. The method according to claim 16, wherein the extract is applied on the seeds, leaves, and/or stem of the plant, or to a growth-medium or soil of a plant.

20. The method according to claim 16, wherein applying the extract comprises spraying the extract on the plant to be treated, watering the extract on the plant, or applying the extract on a substrate in which the plant is growing, the substrate being selected from soil, peat, compost, vermiculite, perlite, sand, or clay.

21. The method according to claim 16, wherein the nematodes are root-knot nematodes, root-lesion nematodes, and/or cyst nematodes.

22. The method according to claim 21, wherein the nematode belongs to the genus selected from the group consisting of Meloidogyne, Heterodera, Globodera, Pratylenchus, Aphelenchoides, Xiphinema, Radopholus, Bursaphelenchus, Rotylenchulus, Nacobbus, Longidorus, Ditylenchus, and Trichodorus.

23. The method according to claim 16, wherein the nematode is selected from the group consisting of Heterodera schachtii, Heterodera avenae, Heterodera glycines, Heterodera sacchari, Heterodera carotae, Globodera pallida, Globodera rostochiensis, Meloidogyne graminicola, Meloidogyne javanica, Meloidogyne incognita, Meloidogyne arenaria, Meloidogyne chitwoodi, Meloidogyne artiellia, Meloidogyne fallax, Meloidogyne hapla, Meloidogyne microtyla, Meloidogyne partityla, Meloidogyne panyuensis, Meloidogyne naasi, Meloidogyne exigua, Meloidogyne enterolobii, Meloidogyne paranaensis, Pratylenchus penetrans, Pratylenchus coffeae, Pratylenchus neglectus, Pratylenchus zeae, Pratylenchus loosi, Pratylenchus brachyurus, Pratylenchus thornei, Aphelenchoides besseyi, Aphelenchoides fragariae, Xiphinema index, Radopholus similis, Bursaphelenchus xylophilus, Rotylenchulus reniformis, Nacobbus abberans, Longidorus elongatus, Ditylenchus destructor, Ditylenchus dipsaci, Ditylenchus angustus, and Tricochodorus minor.

24. The method according to claim 16, wherein the nematode is a root-knot nematode.

25. The method according to claim 16, wherein the extract is applied by spraying, immersion, atomizing, foaming, fogging, coating, or encrusting.

26. The method according to claim 16, wherein the extract is applied on the leaves of a plant.

27. A composition comprising:
an extract of a peel of a fruit of a plant of the genus Cucurbita or Cucumis; and
a surfactant or an agriculturally and/or horticulturally acceptable carrier.

28. The composition according to claim 27, wherein the fruit is a pumpkin, squash, zucchini, melon, gourd, or cucumber.

29. The composition according to claim 27, wherein the composition is formulated as a spraying formulation.

30. A process for the preparation of a composition according to claim 27, the process comprising:
(a) peeling fruits of a plant of the genus Cucurbita or Cucumis to obtain peels;
(b) blending or mixing the peels, optionally in the presence of a solvent, to obtain a blend or mixture;
(c) sieving the blend or mixture; and
(d) adding to the blend or mixture a surfactant or an agriculturally and horticulturally acceptable carrier.

31. The process according to claim 30, wherein at least (b) and (c) are performed at a temperature from about 1° C. to about 40° C.

32. The process according to claim 30, further comprising boiling the peels obtained in (a) in water or a water-based buffer for at least 2 minutes and up to 15 minutes, at about 95° C. to about 150° C.

33. The process according to claim 30, wherein (d) comprises adding a surfactant selected from the group consisting of polyoxyethylene (20) sorbitan monolaurate, ethoxylated fatty amines, alkylphenol ethoxylate-based surfactants, alcohol ethoxylate-based surfactants, silicone-based surfactants, and vegetable oils.

34. A plant seed coated with an extract, wherein the extract is from a plant or part thereof belonging to the genus Cucurbita or Cucumis.

35. A foliar spray comprising the composition according to claim 27.
